(19) United States
(12) Patent Application Publication
(10) Pub. No.: US 2006/0101496 A1
(43) Pub. Date: May 11, 2006

(54) Targeted messaging for a content distribution network

(75) Inventor: Yasser F. Syed, Boulder, CO (US)

Correspondence Address: PATTON BOGGS, 1660 LINCOLN ST, SUITE 2050, DENVER, CO, 80264, US

(73) Assignee: Cable Television Laboratories, Inc., Louisville, CO (US)

(21) Appl. No.: 10/982,722

(22) Filed: Nov. 5, 2004

(51) Int. Cl. H04N 7/18; H04N 7/173

(52) U.S. Cl. 725/78; 725/74; 725/86

(57) ABSTRACT

The targeted messaging system provides a mechanism to both identify a business provider of content and uniquely identify the content that is being provided to the consumer on their consumer device. The present targeted messaging system also provides an interactive link for a user interface that implements a common way for the consumer to communicate with the business provider of the content or its designated proxy across a variety of cable operator systems and content providers. The operation is common across different created applications which are created to implement similar functions.

### FIELD OF THE INVENTION

This invention relates to the field of cable and satellite content distribution networks and the interactive digital television bitstreams used therein to supply a user with access to a targeted WEB page.

### Problem

It is a problem in the field of cable and satellite content distribution networks to provide interactive digital television bitstreams and, more particularly, to supply a consumer with access to a targeted WEB page. In particular, there is a need to link a consumer with a specific source of information, such as a WEB page, when the consumer is receiving a particular content stream (also termed “asset” herein) and needs to access this additional information.

There is presently no mechanism for the consumer to communicate with the business provider of the presently received content in a non-proprietary sense. In existing cable and satellite content distribution networks, it is difficult to provide a general application method to create functions that universally identify the business provider, go to the site maintained by the business provider of the presently received content, and send a message to the business provider to indicate the specific type of content presently being provided by this business provider to the consumer on their consumer device. Therefore, there is no way for the business provider to link the consumer to additional data, since there is no method of determining what additional information is relevant to the presently received content.

### Solution

The above-described problems are solved and a technical advance achieved by the Targeted Messaging For A Content Distribution Network (termed “targeted messaging system” herein), which provides a mechanism to both identify a business provider of content and uniquely identify the content that is being provided to the consumer on their consumer device. The present targeted messaging system also provides an interactive link for a user interface that implements a common way for the consumer to communicate with the business provider of the content or its designated proxy across a variety of cable operator systems and content providers, regardless of the content: Video on Demand, games, software, audio, and the like.

This is accomplished by using the Video on Demand (VOD) Metadata Asset distribution identifier, which comprises a Provider ID and an Asset ID, to identify a business provider of this content that is transmitted to the consumer device along with the subscriber selected content. This identification is accomplished through the Provider ID, which is a registered domain name given by the business provider. The Asset ID component of the Video on Demand (VOD) Metadata Asset distribution identifier then uniquely identifies the content that is presently being provided by this business provider to the consumer on their consumer device. The Asset ID can also be used to identify a specific default WEB page that is controlled by the content provider or by a proxy associated with that content. If the Set Top Box or consumer device that is receiving the content is part of a two-way communication network or has an IP path and is aware of the unique identifier (Provider ID/Asset ID), this unique identifier can be used for a targeted messaging signal to the asset agent for the business provider of this content. The asset agent can be a cable company that delivers the content or the original business provider of the content.

The targeted messaging system opens a line of communication from the consumer to the asset agent for the business provider of this content and provides a means to identify what content is presently being addressed. In existing content distribution networks, there is presently no mechanism for the consumer to communicate with the asset agent in a non-proprietary sense. The targeted messaging system provides the consumer with a common way to communicate with the asset agent across a variety of cable operator systems and content providers.

### BRIEF DESCRIPTION OF THE DRAWINGS

FIG. 1 illustrates a typical default User Interface page that would be displayed to the consumer on their consumer device;

FIG. 2 illustrates a typical response to the User Interface page of FIG. 1 that would be displayed to the consumer on their consumer device;

FIGS. 3A and 3B illustrate alternative communication scenarios that implement the present targeted messaging system;

FIG. 4 illustrates a typical data set that can be used to address a specific WEB page that is designed for the user response of FIG. 2; and

FIG. 5 illustrates a typical response User Interface page that would be displayed to the consumer on their consumer device.

### DETAILED DESCRIPTION OF THE DRAWINGS

System Environment

A Cable Modem Termination System (CMTS) is a system of devices that allows cable television operators to offer high-speed Internet access to home computers. The Cable Modem Termination System sends and receives digital cable modem signals on a cable network, receiving signals sent upstream from a subscriber's cable modem, converting the signals to IP packets, and routing the signals on to an Internet Service Provider (ISP) for connection to the Internet. The Cable Modem Termination System also sends signals downstream from the Internet to the user's cable modem. Cable modems cannot communicate directly with each other; they must communicate by channeling their signals through the Cable Modem Termination System.

DOCSIS (Data Over Cable Service Interface Specification) is a standard interface for cable modems, the devices that handle incoming and outgoing data signals between the cable operator and a subscriber's personal or business computer or television set. DOCSIS specifies modulation schemes and the protocol for exchanging the bi-directional signals over cable. In other words, DOCSIS is the protocol used for sending and receiving signals between the subscriber cable modem and the CMTS where the signals are converted to/from DOCSIS from/to IP packets.

In a DOCSIS-based cable data system, data on an individual subscriber's data use is collected by various means and uniquely identified by tagging the data collected with the Media Access Control (MAC) address of the subscriber's modem. The MAC address of the subscriber's modem is the modem's unique hardware number assigned to the cable modem by the manufacturer of the cable modem. When the subscriber is connected to the Internet, a corresponding table is used to correlate the subscribers IP address to the cable modem's MAC address. A data collection engine may be interfaced to the Cable Modem Termination System in the cable operator's network. In a DOCSIS-based cable high-speed data system, data on an individual subscriber's data use is collected by various means and uniquely identified by tagging the data collected with the Media Access Control (MAC) address of the subscriber's cable modem. The MAC address of the subscriber's cable modem is the cable modem's unique hardware number. When the subscriber is connected to the Internet, a corresponding database is used to correlate the subscriber's IP address to the cable modem's physical MAC address. The MAC address is used for routing data over the cable network while the IP address is used for routing data over the Internet.

Architecture of the Targeted Messaging System

The targeted messaging system provides a mechanism to both identify a business provider of content and uniquely identify the content that is being provided to the consumer on their consumer device. The content that is sent can be through a traditional MPEG-2 Cable Network or through an IP connection. The present targeted messaging system also provides an interactive link for a user interface that implements a common way for the consumer to communicate with the business provider of the content or its designated proxy across a variety of cable operator systems and content providers. This communication is through any number of application products that design around this targeted message system.

This is accomplished by providing a default interactive link for the User Interface. Most content for Cable Video on Demand (VOD) uses the CableLabs Video On Demand Metadata specifications which provide the unique identifier combination of Provider ID/Asset ID. If this Provider ID/Asset ID Metadata is transmitted to the Set Top Box or consumer device along with the content, then each asset provides sufficient data to enable the consumer device to provide an interactive link through an IP interface that can signal the content provider or cable operator with regard to a specific asset. This common link can be used to develop applications that work across many equipment platforms. There is value for this in targeted advertising, three-party marketing (coupons, merchandise, etc.), reporting, default screens, and interactive applications. The metadata included in this system incorporates simple elements such as the title of a Video on Demand movie as well as more complex elements, including information on how the content is licensed and displayed. Up to now, Cable Video on Demand content owners, server system providers, and set-top box makers have used their own proprietary metadata schemes. Using a common metadata specification helps cable operators cut Video on Demand operating costs and makes it easier for them to manage available bandwidth. Content providers could reduce production costs, and for set-top box makers it would be easier to integrate metadata with channel navigation software and electronic programming guides.

For this type of signaling, it is sufficient to use an interactive link connected to an IP distribution connection, which interactive link can be shared by many assets. Through the CableLabs Video on Demand Metadata specs, there is always a default link attached to every asset. An IP interactive link can be developed around this default link and the IP interactive link can behave differently according to the specific asset that is being used. This approach can make use of IP distribution or through Video on Demand return channel.

This is accomplished by using the Video on Demand Metadata Asset distribution identifier, which comprises a provider ID and an asset ID, to identify a business provider of this content. This identification is accomplished through the provider ID, which is a registered domain name given by the business provider. The asset ID component of the Video on Demand Metadata Asset distribution identifier then uniquely identifies the content that is presently being provided by this business provider to the consumer on their consumer device. The asset ID can also be used to identify a specific default WEB page that is controlled by the content provider or by a proxy associated with that content. If the Set Top Box or consumer device that is receiving the content is part of a two-way communication network or has an IP path and is aware of the unique identifier (provider ID/asset ID), this unique identifier can be used for a targeted messaging signal to the asset agent for the business provider of this content. The asset agent can be a cable company that delivers the content or the original business provider of the content.

The targeted messaging system opens a line of communication from the consumer to the asset agent for the business provider of this content and provides a means to identify what content is presently being addressed. In existing content distribution networks, there is presently no mechanism for the consumer to communicate with the asset agent in a non-proprietary sense. The targeted messaging system provides the consumer with a common way to communicate with the asset agent across a variety of cable operator systems and content providers. This allows for competitive application products to be built and be interoperable on concepts involving this approach.

Operation of the Targeted Messaging System

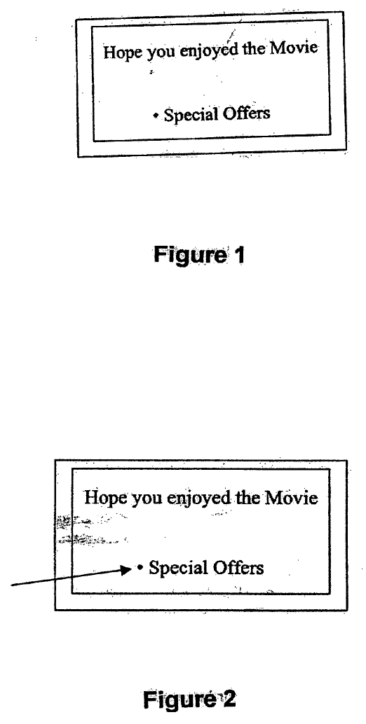

FIGS. 1-5 illustrate a typical implementation of the present targeted messaging system. In particular, FIG. 1 illustrates a typical default User Interface page that would be displayed to the consumer on their consumer device. Typically, this display is provided to the consumer at the conclusion of a particular stream of content (asset), such as at the end of a movie. The display indicates one or more choices that are available to the consumer, such as “special Offers” as displayed in FIG. 1. FIG. 2 illustrates a typical response to the User Interface page of FIG. 1 that would be displayed to the consumer on their consumer device. In particular, the consumer can activate a control to identify one of the one or more choices and indicate their selection. The control is typically a user interface device that enables the consumer to control the operation of the Set Top Box.

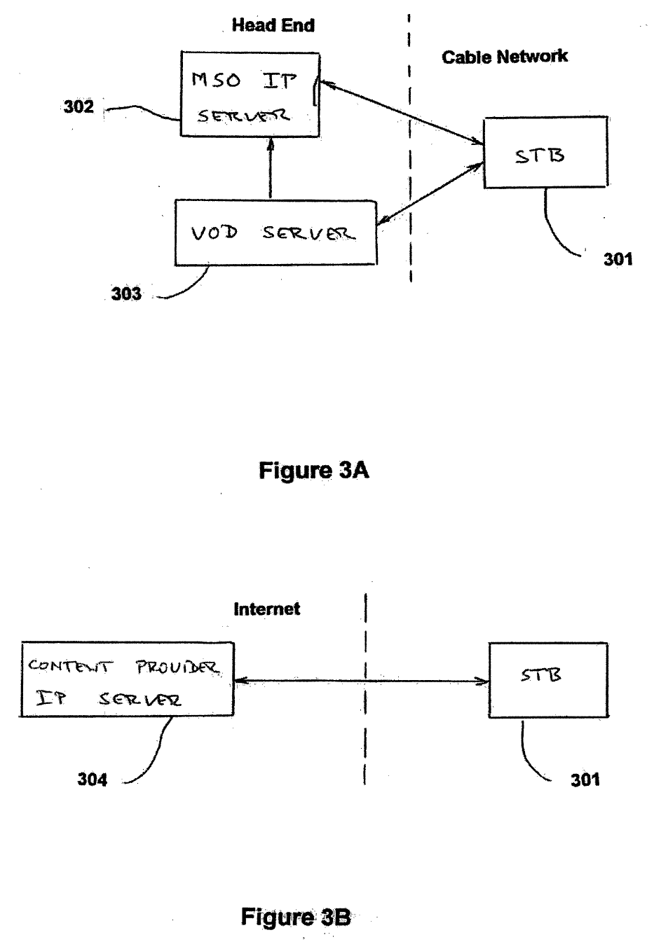

FIGS. 3A and 3B illustrate alternative communication scenarios that implement the present targeted messaging system. In the scenario of FIG. 3A, the selection of a choice by the consumer is detected by the Set Top Box 301 and conveyed to the MSO IP Server 302 either directly over an IP connection or via the Video on Demand Server 303. The data transmitted by the Set Top Box 301 includes not only the consumer selection, but also the unique identifier comprising the Provider ID/Asset ID that identify the particular content (asset) presently received by the consumer device. This identifier does not necessarily have to be visible to the consumer. The MSO IP Server 302 processes this request and provides the requested data to the consumer via the consumers Set Top Box over the interactive IP link. Alternatively, as shown in FIG. 3B, the Set Top Box 301 transmits the unique identifier comprising the Provider ID/Asset ID that identify the particular content (asset) presently received by the consumer device directly to the Content Provider IP Server 304. This connection is implemented over the Internet and enables a direct interaction between the consumer device or Set Top Box and the Content Provider IP Server 304.

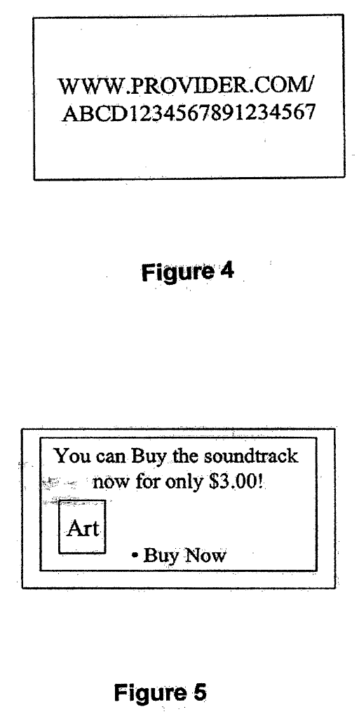

FIG. 4 illustrates a typical data set that can be used to address a specific WEB page that is designed for the user response of FIG. 2. Since the Provider ID includes the WEB address (registered Internet domain) of the content provider, it can be directly used to link to the Content Provider IP Server 304 or used by the MSO to identify a set of WEB pages associated with the content provider. The remainder of the IP address illustrated in FIG. 4 comprises an Asset ID which denotes the particular asset presently received by the consumer device. Note this does not have to be visible to the consumer.

FIG. 5 illustrates a typical response User Interface page that would be displayed to the consumer on their consumer device. The content of this User Interface page can include a simple WEB page or applets that are downloaded to the Set Top Box. The display can include one or more choices that the consumer can select and activate to either link to other WEB pages or to initiate a commercial transaction, such as a purchase from the content provider or agent.

### SUMMARY

The targeted messaging system provides a mechanism to both identify a business provider of content and uniquely identify the content that is being provided to the consumer on their consumer device. The present targeted messaging system also provides an interactive link for a user interface that implements a common way for the consumer to communicate with the business provider of the content or its designated proxy across a variety of cable operator systems and content providers.

What is claimed:

1. A method for implementing interactive bidirectional communication between devices in a home and content servers in a cable network for delivering data content, comprising:
means for maintaining a metadata link between devices in a home and content system servers in a cable network for the exchange of IP control data; and
means, responsive to the receipt of said control data from a one of said devices in a home by said content system servers, for creating a unidirectional communication session from said content system servers to said one device for delivering data content.

2. The system for implementing interactive bidirectional communication of claim 1 further comprising:
means for identifying what content is presently being delivered to said devices in a home using a unique identifier for said content.

3. The system for implementing interactive bidirectional communication of claim 2 further comprising:
means for transmitting said unique identifier to said devices in a home in conjunction with transmission of said content identified by said unique identifier to said devices in a home.

4. The system for implementing interactive bidirectional communication of claim 3 wherein said means for creating comprises:
means, responsive to receipt of said unique identifier from a one of said devices in a home and control data, for transmitting predetermined content to said one device.

5. The system for implementing interactive bidirectional communication of claim 4 wherein said means for creating further comprises:
means, responsive to receipt of control data indicative of a selection made by a consumer at said one device, for transmitting predetermined content identified by said selection to said one device.

6. The system for implementing interactive bidirectional communication of claim 1 further comprising:
means for transmitting a unique identifier combination of Provider ID/Asset ID to said devices in a home in conjunction with transmission of an asset identified by said unique identifier combination of Provider ID/Asset ID to said devices in a home.

7. The system for implementing interactive bidirectional communication of claim 6 wherein said means for creating comprises:
means, responsive to receipt of said unique identifier combination of Provider ID/Asset ID and control data from a one of said devices in a home, for transmitting predetermined content to said one device.

8. The system for implementing interactive bidirectional communication of claim 7 wherein said means for creating further comprises:
means, responsive to receipt of control data indicative of a selection made by a consumer at said one device, for transmitting predetermined content identified by said selection to said one device.
